(19) United States
(12) Patent Application Publication
(10) Pub. No.: US 2026/0186700 A1
(43) Pub. Date: Jul. 2, 2026

(54) MEMORY CONTROLLER, OPERATING METHOD OF MEMORY CONTROLLER, AND STORAGE DEVICE COMPRISING MEMORY CONTROLLER

(71) Applicant: Samsung Electronics Co., Ltd., Suwon-si (KR)

(72) Inventors: MyungGwan JEONG, Suwon-si (KR); Donggil KANG, Suwon-si (KR); Jongmin KIM, Suwon-si (KR); Jinwoo SONG, Suwon-si (KR); Gyeonghwan YU, Suwon-si (KR); Kyeongtae PARK, Suwon-si (KR); Kyungsik UM, Suwon-si (KR); Minsik OH, Suwon-si (KR); Jinmyung YOON, Suwon-si (KR)

(73) Assignee: Samsung Electronics Co., Ltd., Suwon-si (KR)

(21) Appl. No.: 19/278,282

(22) Filed: Jul. 23, 2025

(30) Foreign Application Priority Data
Dec. 27, 2024 (KR) 10-2024-0199107

(51) Int. Cl. G06F 3/06

(52) U.S. Cl. CPC G06F 3/0656; G06F 3/0611; G06F 3/065; G06F 3/0659; G06F 3/0679

(57) ABSTRACT

According to some example embodiments an operating method of a memory controller includes buffering first user data received from a host in a first region of a buffer memory corresponding to a first memory region of a memory device, receiving a flush request from the host, duplicating the first user data in a second region of the buffer memory corresponding to a second memory region of the memory device, padding, as padded data, the first user data duplicated to the second region with dummy data, programming the padded data in the second memory region of the memory device, buffering second user data received from the host in the first region, and programming, in the first memory region of the memory device, the first user data buffered in the first region and the second user data buffered in the first region.

### CROSS-REFERENCE TO RELATED APPLICATION

This application claims priority under 35 U.S.C. § 119 to Korean Patent Application No. 10-2024-0199107, filed on Dec. 27, 2024, in the Korean Intellectual Property Office, the disclosure of which is incorporated herein by reference in its entirety.

### BACKGROUND

Some example embodiments of the present inventive concepts described herein relate to a memory controller, and more particularly, to a memory controller, an operating method of a memory controller, and/or a storage device including the memory controller.

A semiconductor memory is classified as a volatile memory, which loses data stored therein when a power is turned off, such as a static random access memory (SRAM) and/or a dynamic random access memory (DRAM), or a nonvolatile memory, which retains data stored therein even when a power is turned off, such as a flash memory, a phase-change RAM (PRAM), a magnetic RAM (MRAM), a resistive RAM (RRAM), and/or a ferroelectric RAM (FRAM).

A flash memory device is being widely used as a high-capacity storage medium of a computing system. The flash memory device is configured to communicate with a memory controller based on various electrical signals. The memory controller may store user data buffered in a buffer memory in the flash memory device in response to receiving a flush request from a host.

### SUMMARY

Some example embodiments of the present inventive concepts provide a memory controller having improved performance.

According to some example embodiments, an operating method of a memory controller includes buffering first user data received from a host in a first region of a buffer memory corresponding to a first memory region of a memory device, receiving a flush request from the host, duplicating the first user data in a second region of the buffer memory corresponding to a second memory region of the memory device, padding, as padded data, the first user data duplicated to the second region with dummy data, programming the padded data in the second memory region of the memory device, buffering second user data received from the host in the first region, and programming, in the first memory region of the memory device, the first user data buffered in the first region and the second user data buffered in the first region.

According to some example embodiments, a memory controller includes a buffer memory including a first region corresponding to a first memory region of a memory device, and a second region corresponding to a second memory region of the memory device. The memory controller configured to buffer first user data received from a host in the first region, receive a flush request from the host, duplicate the first user data to the second region, pad, as padded data, the first user data duplicated to the second region with dummy data, program the padded data in the second memory region, buffer second user data received from the host in the first region, and program, in the first memory region, the first user data buffered in the first region and the second user data buffered in the first region.

According to some example embodiments, a storage device includes a memory device including a first memory region and a second memory region, and a memory controller configured to control the memory device. The memory controller including a buffer memory, the buffer memory including a first region corresponding to the first memory region of the memory device and a second region corresponding to the second memory region of the memory device. The memory controller configured to buffer first user data received from a host in the first region, receive a flush request from the host, duplicate the first user data to the second region, pad, as padded data, the first user data duplicated to the second region with dummy data, program the padded data in the second memory region, buffer second user data received from the host in the first region, and program, in the first memory region, the first user data buffered in the first region and the second user data buffered in the first region.

According to some example embodiments, an operating method of a storage device including a memory device and a memory controller is provided, the method comprising buffering first user data received from a host in a first region of a buffer memory of the memory controller, the first region corresponding to a first memory region of the memory device; receiving a flush request from the host; duplicating the first user data to a second region of the buffer memory of the memory controller, the second region corresponding to a second memory region of the memory device; padding, as padded data, the first user data duplicated to the second region with dummy data; programming the padded data in the second memory region of the memory device; buffering second user data received from the host in the first region of the buffer memory; and programming, in the first memory region of the memory device, the first user data buffered in the first region of the buffer memory and the second user data buffered in the first region of the buffer memory.

In some example embodiments, the first memory region of the memory device is an n-bit multi-level cell (MLC) region, the second memory region of the memory device is one of an m-bit MLC region or a single level cell (SLC) region, “m” is a first natural number greater than 1, and “n” is a second natural number greater than “m”.

In some example embodiments, a first size of the first region of the buffer memory corresponds to a second size of a first page of the first memory region of the memory device, and a third size of the second region of the buffer memory corresponds to a fourth size of a second page of the second memory region of the memory device.

In some example embodiments, the programming the padded data in the second memory region of the memory device includes performing a first update operation on a mapping table, and the programming the first user data in the first memory region of the memory device and the second user data in the first memory region of the memory device includes performing a second update operation on the mapping table.

### BRIEF DESCRIPTION OF THE DRAWINGS

The above and other objects and features of the present inventive concepts will become apparent by describing in detail some example embodiments thereof with reference to the accompanying drawings.

FIG. 1 illustrates a storage device according to some example embodiments.

FIG. 2 illustrates a memory controller according to some example embodiments.

FIG. 3 illustrates a memory device according to some example embodiments.

FIG. 4 illustrates a state of a buffer memory before a memory controller receives a flush request, according to some example embodiments.

FIG. 5 is a diagram for describing a method in which a memory controller operates when a flush request is received, according to some example embodiments.

FIGS. 6A and 6B are diagrams for describing a method in which a memory controller operates when a flush request is received, according to some example embodiments.

FIGS. 7A and 7B are diagrams for describing a method in which a memory controller operates when a flush request is received, according to some example embodiments.

FIG. 8 illustrates an operating method of a memory controller according to some example embodiments.

FIG. 9 illustrates an operation in which a memory controller receives a flush request, in detail according to some example embodiments.

FIG. 10 illustrates an operation in which a memory controller programs padded data in a memory device, in detail according to some example embodiments.

FIG. 11 illustrates an operation in which a memory controller programs first user data and second user data in a memory device, in detail according to some example embodiments.

FIG. 12 is a block diagram illustrating a memory system according to some example embodiments.

FIG. 13 is a diagram illustrating a system to which a storage device according to some example embodiments is applied.

### DETAILED DESCRIPTION

Below, some example embodiments of the present inventive concepts will be described in detail and clearly to such an extent that an ordinary one in the art easily carries out the present inventive concepts.

In the detailed description, components which are described with reference to the term's “unit”, “module”, “block”, “˜er or ˜or”, etc., and function blocks which are illustrated in drawings will be implemented in the form of software or hardware and/or a combination thereof. For example, the software may include a machine code, firmware, an embedded code, and application software. For example, the hardware may include an electrical circuit, an electronic circuit, a processor, a computer, an integrated circuit, integrated circuit cores, a pressure sensor, an inertial sensor, a microelectromechanical system (MEMS), a passive element, and/or a combination thereof.

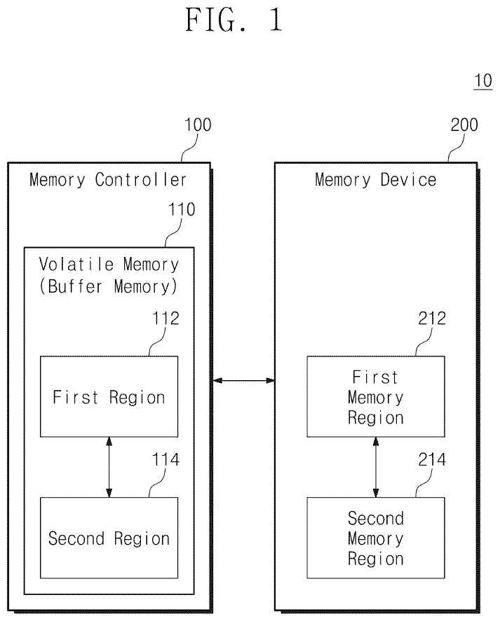

FIG. 1 illustrates a storage device according to some example embodiments. Referring to FIG. 1, a storage device 10 may include a memory controller 100 and a memory device 200.

In some example embodiments, depending on a request of an external device (e.g., an external host device, a CPU, and/or an AP) or under control of the external device, the memory controller 100 may store data in the memory device 200 or may read data stored in the memory device 200.

The memory device 200 may include a plurality of memory blocks. In some example embodiments, under control of the memory controller 100, the memory device 200 may store data in the plurality of memory blocks or may provide data stored in the plurality of memory blocks to the memory controller 100. In some example embodiments, the memory device 200 may be implemented with a NAND flash memory device, but example embodiments are not limited thereto.

The memory controller 100 according to some example embodiments may include a volatile memory (or a buffer memory) 110. The memory controller 100 may receive user data to be stored in the memory device 200 from the host. For example, the memory controller 100 may receive a write request (or a write command) and the user data from the host. The memory controller 100 may store the user data received from the host in the buffer memory 110. For example, the memory controller 100 may buffer the user data in the buffer memory 110 before programming the user data in the memory device 200. The memory controller 100 may store the buffered user data in the memory device 200 in response to that the size of the user data stored in the buffer memory 110 reaches the size of a program unit.

In some example embodiments, the program unit which is a basic unit of the write operation of data in the memory device 200 may correspond to a super page composed of a plurality of physical pages of the memory device 200. For example, the super page may be a set of physical pages which are connected to the same word line and are distributed into a plurality of planes or a plurality of banks. The memory device 200 may program data in a plurality of physical pages in parallel by performing the data write operation in the program unit corresponding to the super page.

In some example embodiments, before the size of the user data buffered in the buffer memory 110 reaches the size of the program unit, the memory controller 100 may receive a flush request (or a flush command) from the host. The memory controller 100 may store the user data buffered in the buffer memory 110 in the memory device 200 in response to receiving the flush request. For example, the memory controller 100 may pad the user data buffered in the buffer memory 110 with dummy data to complete the program unit and may store the padded data in the memory device 200.

The buffer memory 110 may include a first region 112 and a second region 114, and the memory device 200 may include a first memory region 212 and a second memory region 214. The first region 112 and the second region 114 may respectively correspond to the first memory region 212 and the second memory region 214. For example, the size of the first region 112 may correspond to the size of the first memory region 212, and the size of the second region 114 may correspond to the size of the second memory region 214. For example, each of the first memory region 212 and the second memory region 214 may be any one of the plurality of memory blocks included in the memory device 200.

According to some example embodiments, the first region 112 and the second region 114 included in the buffer memory 110 may not be regions which are physically distinguished from each other. For example, the first region 112 and the second region 114 are illustrated as being distinguished from each other for convenience of description, and as described above, according to some example embodiments, the first region 112 and the second region 114 may be regions which are distinguished from each other logically, not physically.

For example, the user data being buffered in the first region 112 corresponding to the first memory region 212 may mean that a target region of the memory device 200, in which the user data will be programmed, is the first memory region 212, and the user data being buffered in the second region 114 corresponding to the second memory region 214 may mean that a target region of the memory device 200, in which the user data will be programmed, is the second memory region 214.

For example, the buffer memory 110 may store meta data, which include information about the target region of the memory device 200 in which the corresponding user data will be programmed, together with the user data of the buffer memory 110. For example, the memory controller 100 may determine a region of the memory device 200, in which the user data will be programmed, based on the meta data stored in the buffer memory 110. For example, the memory controller 100 may change a region of the memory device 200, in which the user data will be programmed, by updating the meta data stored in the buffer memory 110 and/or may allow the user data to be programmed in a plurality of regions of the memory device 200.

Each of the plurality of memory blocks included in the memory device 200 may be implemented with any one of a single level cell (SLC) memory block storing one bit and a multi-level cell (MLC) memory block storing K bits (K being a natural number greater than 1). For example, when K is 2, the memory block may be a 2-bit MLC memory block (or an MLC memory block); when K is 3, the memory block may be a 3-bit MLC memory block (or a TLC memory block); and, when K is 4, the memory block may be a 4-bit MLC memory block (or a quad level cell (QLC) memory block). Accordingly, the plurality of memory blocks included in the memory device 200 may have different kinds of storage methods and/or operations. For example, the plurality of memory blocks may include two or more of the SLC memory block, the MLC memory block, the TLC memory block, and the QLC memory block.

For example, the first memory region 212 of the memory device 200 may be an n-bit MLC region corresponding to an n-bit MLC memory block, and the second memory region 214 of the memory device 200 may be any one of an m-bit MLC region corresponding to an m-bit MLC memory block and an SLC region corresponding to an SLC memory block. Herein, “m” is a natural number greater than 1, and “n” is a natural number greater than “m”.

According to some example embodiments, the buffer memory 110 may correspond to the n-bit MLC region, and the second region 114 of the buffer memory 110 may correspond to any one of the m-bit MLC region and the SLC region. For example, the size of the first region 112 may correspond to the size of a page being the program unit of the n-bit MLC memory block, and the size of the second region 114 may correspond to the size of a page being the program unit of the m-bit MLC memory block and the SLC memory block.

According to some example embodiments, for convenience, the description will be given as the first memory region 212 is the TLC region corresponding to the TLC memory block and the second memory region 214 is the SLC region corresponding to the SLC memory block. However, this is provided as an example, and should not be interpreted to limit the scope of the present inventive concepts.

According to some example embodiments, because the TLC memory block stores 3-bit data per cell, the size of the program unit of the TLC memory block may be three times the size of a single page. In some example embodiments, because the SLC memory block stores 1-bit data per cell, the size of the program unit of the SLC memory block may be identical to the size of a single page. Accordingly, in some example embodiments, the size of the first region 112 of the buffer memory 110 may correspond to three times the size of the single page, and the size of the second region 114 of the buffer memory 110 may correspond to the size of the single page. For example, the size of the first region 112 of the buffer memory 110 may be a TLC program unit, and the size of the second region 114 of the buffer memory 110 may be an SLC program unit.

The memory controller 100 may receive first user data to be stored in the memory device 200 from the host. The memory controller 100 may buffer the first user data in the first region 112 of the buffer memory 110. For example, the size of the first user data may be identical to the size of the second region 114 or may be smaller than the size of the second region 114.

The memory controller 100 may receive the flush request from the host. For example, before the size of the first user data buffered in the first region 112 of the buffer memory 110 reaches the size of the program unit, the memory controller 100 may receive the flush request from the host. According to some example embodiments, the first user data may be user data received from the host before the memory controller 100 receives the flush request from the host.

The memory controller 100 may duplicate the first user data buffered in the first region 112 of the buffer memory 110 to the second region 114 of the buffer memory 110. For example, the memory controller 100 may compare the size of the first user data buffered in the first region 112 with the size of the second region 114 in response to receiving the flush request from the host, and when the size of the first user data is identical to the size of the second region 114 or is smaller than the size of the second region 114, the memory controller 100 may duplicate the first user data to the second region 114 of the buffer memory 110.

In some example embodiments, the first region 112 and the second region 114 of the buffer memory 110 may not be regions which are physically distinguished from each other. For example, an operation in which the memory controller 100 duplicates the first user data buffered in the first region 112 to the second region 114 may be an operation in which the memory controller 100 updates meta data including information about a target region of the memory device 200, in which the first user data will be programmed. For example, the memory controller 100 may update the meta data stored in the buffer memory 110 together with the first user data such that both the first memory region 212 and the second memory region 214 are used as a target region of the memory device 200, in which the first user data will be programmed.

The memory controller 100 may pad the first user data duplicated to the second region 114 with dummy data. For example, when the size of the first user data is smaller than the size of the second region 114, the memory controller 100 may generate the padded data by filling a portion of the second region 114, in which the first user data are not filled, with dummy data. For example, the size of the padded data may be identical to the size of the second region 114.

The memory controller 100 may program the padded data of the second region 114 in the second memory region 214 of the memory device 200. For example, because the size of the padded data is identical to the size of the second region 114, the memory controller 100 may program the padded data in the second memory region 214 (e.g., the SLC memory region) of the memory device 200 corresponding to the second region 114 as the SLC program unit.

Although not illustrated, in some example embodiments, the memory controller 100 may include a mapping table which maps a logical page number (LPN) (or a logical address) received from the host and a physical page number (PPN) (or a physical address) of the memory device 200. In response to the padded data being completely programmed in the second memory region 214, the memory controller 100 may perform a first update operation on the mapping table. For example, in response to the padded data being completely programmed in the second memory region 214, the memory controller 100 may update the mapping table such that the logical page number received from the host is mapped to the physical page number of the second memory region 214 of the memory device 200, in which the padded data are programmed.

In some example embodiments, after the padded data are completely programmed in the second memory region 214, the memory controller 100 may not release the first user data buffered in the buffer memory 110. For example, even after the padded data are completely programmed in the second memory region 214, the memory controller 100 may maintain the first user data of the buffer memory 110 without releasing the first user data.

For example, in response to the user data buffered in the buffer memory 110 being completely programmed, the memory device 200 may transmit and/or send a program done signal to the memory controller 100. As the memory controller 100 receives the program done signal, the memory controller 100 may determine whether the received program done signal is a program done signal associated with the user data duplicated by the flush request. For example, when the received program done signal is the program done signal associated with the duplicated user data, the memory controller 100 may not release the first user data buffered in the buffer memory 110. In some example embodiments, when the received program done signal is not the program done signal associated with the duplicated user data, the memory controller 100 may release the first user data and second user data buffered in the buffer memory 110.

For example, the memory device 200 may transmit and/or send the program done signal to the memory controller 100 in response to the padded data being completely programmed in the second memory region 214. In some example embodiments because the program done signal received from the memory device 200 corresponds to the program done signal associated with the user data duplicated by the flush request, the memory controller 100 may not release the first user data buffered in the buffer memory 110.

In some example embodiments, the memory controller 100 may receive the second user data to be stored in the memory device 200 from the host. The memory controller 100 may buffer the second user data in the first region 112 of the buffer memory 110. For example, the memory controller 100 may buffer the second user data in the first region 112 of the buffer memory 110 in which the first user data are buffered. For example, a size obtained by adding the size of the first user data and the size of the second user data may be identical to the size of the first region 112. According to some example embodiments, the second user data may be subsequent user data received from the host after the memory controller 100 receives the flush request from the host.

For example, after the padded data are completely programmed in the second memory region 214, because the memory controller 100 does not release the first user data buffered in the buffer memory 110, the meta data stored in the buffer memory 110 may include existing information indicating that a target region of the memory device 200, in which the first user data will be programmed, is the first memory region 212. Accordingly, the second user data may be buffered in the first region 112 of the buffer memory 110 together with the first user data.

The memory controller 100 may program the first user data and the second user data buffered in the first region 112 in the first memory region 212 of the memory device 200. For example, because a size obtained by adding the size of the first user data and the size of the second user data is identical to the size of the first region 112, the memory controller 100 may program the first user data and the second user data in the first memory region 212 (e.g., the TLC memory region) of the memory device 200 corresponding to the first region 112 as the TLC program unit.

In response to the first user data and the second user data being completely programmed in the first memory region 212, the memory controller 100 may perform a second update operation on the mapping table. For example, in response to the first user data and the second user data being completely programmed in the first memory region 212, the memory controller 100 may update the mapping table such that the logical page number received from the host is mapped to the physical page number of the first memory region 212 of the memory device 200, in which the first user data and the second user data are programmed.

In some example embodiments, after the first user data and the second user data are completely programmed in the first memory region 212, the memory controller 100 may release the first user data and the second user data buffered in the buffer memory 110. For example, in response to the first user data and the second user data being completely programmed in the first memory region 212, the memory controller 100 may release cache data of the buffer memory 110.

For example, the memory device 200 may transmit and/or send the program done signal to the memory controller 100 in response to the first user data and the second user data being completely programmed in the first memory region 212. In some example embodiments because the program done signal received from the memory device 200 does not correspond to the program done signal associated with the user data duplicated by the flush request, the memory controller 100 may release the first user data and the second user data buffered in the buffer memory 110.

As described above, the memory controller 100 according to some example embodiments may be configured to duplicate the first user data to the second region 114 in response to receiving the flush request from the host, skip (or omit) the release operation on the first user data even after the padded data are completely programmed in the second memory region 214, and program the first user data and the second user data in the first memory region 212 together. Accordingly, data sequentiality (e.g., an order of data) of the first user data and the second user data programmed by the memory controller 100 according to some example embodiments may be guaranteed.

For example, when the memory controller 100 receives a read request (or a read command) for the first user data and the second user data programmed in the first memory region 212 from the host, the memory controller 100 may perform the read operation on the first user data and the second user data stored in the memory device 200. For example, assuming that the memory controller 100 receives a sequential read request for the first user data and the second user data from the host, because the first user data and the second user data have been programmed in the memory device 200 as one TLC program unit as described above according to some example embodiments, when the memory controller 100 performs the read operation, the sequential collision (e.g., bank collision) may not occur.

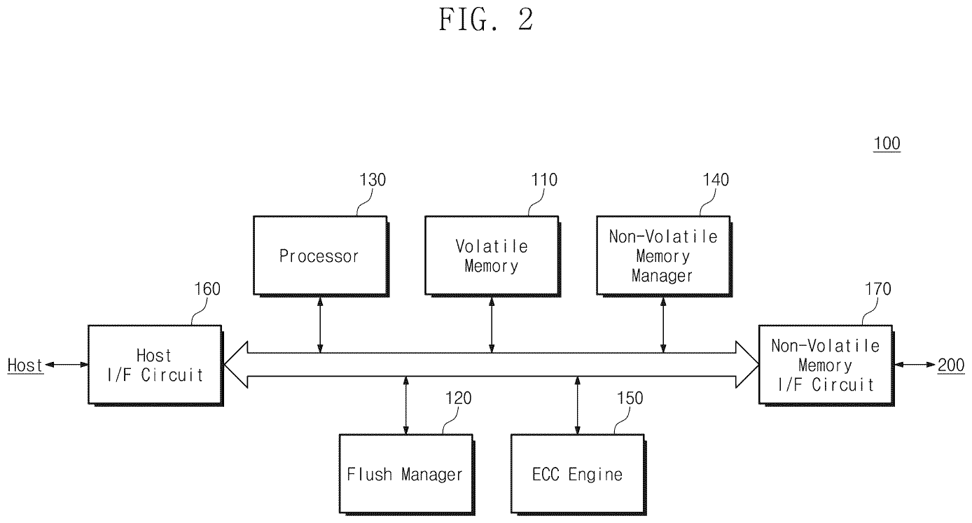

FIG. 2 illustrates a memory controller according to some example embodiments. Referring to FIGS. 1 and 2, the memory controller 100 may include the volatile memory 110, a flush manager 120, a processor 130, a non-volatile memory manager 140, an error correction code (ECC) engine 150, a host interface circuit 160, and a non-volatile memory interface circuit 170.

The volatile memory 110 may be used as a working memory, the buffer memory 110 (e.g., illustrated in FIG. 1), or a system memory of the memory controller 100. For example, the volatile memory 110 may include a volatile memory such as an SRAM or a DRAM. The volatile memory 110 may be configured as the buffer memory 110 described with reference to FIG. 1 and may operate as the buffer memory 110. Accordingly, the same description associated with the volatile memory 110 will be omitted to avoid redundancy.

The flush manager 120 may manage the operation of the memory controller 100 described with reference to FIG. 1 in response to the flush request received from the host. In some example embodiments, when the flush request is received from the host, the flush manager 120 may manage an operation of duplicating first user data buffered in the buffer memory 110, an operation of padding the first user data with dummy data, an operation of programming the padded data in the memory device 200, an operation of programming the first user data and second user data in the memory device 200, an operation of determining whether to perform the release operation on cache data of the buffer memory 110 after each of the program operations are completed, the update operation on the mapping table mapping a logical address from the host and a physical address of the memory device 200, etc.

The processor 130 may control all operations of the memory controller 100. The processor 130 may process information stored in the volatile memory 110 or may execute various firmware and/or program codes stored in the volatile memory 110.

The non-volatile memory manager 140 may perform various management operations on the memory device 200. For example, the non-volatile memory manager 140 may perform various maintenance operations such as a mapping table managing operation of managing mapping information between a physical address of the memory device 200 and a logical address of stored data, a lifetime managing operation of managing the lifetime of the memory device 200 (e.g., a plurality of memory blocks of the memory device 200), a bad block managing operation of managing a bad block of the memory device 200, a wear leveling operation of managing the wear level of the memory device 200, and a garbage collection operation for securing free memory blocks of the memory device 200. In some example embodiments, the non-volatile memory manager 140 may be implemented with a flash translation layer (FTL) configured to perform the management operation on the memory device 200. In some example embodiments, some or all of the functions of the non-volatile memory manager 140 may be implemented through software, hardware, and/or a combination thereof.

In some example embodiments, when the flush request is received from the host, the non-volatile memory manager 140 may perform the mapping table managing operation between a logical address and a physical address under control of the flush manager 120.

The ECC engine 150 may be configured to detect and correct an error of data read from the memory device 200. For example, the ECC engine 150 may generate an error correction code for data to be stored in the memory device 200. The generated error correction code may be stored in the memory device 200 together with the corresponding data. In some example embodiments, the error correction code and the corresponding data may be read from the memory device 200, and the ECC engine 150 may be configured to correct an error of the data read from the memory device 200 by using the error correction code. In some example embodiments, the ECC engine 150 may have an error correction capability of a given level.

The memory controller 100 may communicate with an external host through the host interface circuit 160. The host interface circuit 160 may be implemented based on the given interface protocol. In some example embodiments, the given interface protocol may include at least one of protocols for various interfaces such as a peripheral component interconnect express (PCI-express) interface, a non-volatile memory express (NVMe) interface, a serial ATA (SATA) interface, a serial attached SCSI (SAS) interface, and/or a universal flash storage (UFS) interface, but example embodiments are not limited thereto.

The memory controller 100 may communicate with the memory device 200 through the non-volatile memory interface circuit 170. The non-volatile memory interface circuit 170 may be implemented based a NAND interface, a toggle interface, or an ONFI interface. In some example embodiments, the non-volatile memory interface circuit 170 may include a flash memory controller (FMC) (not illustrated) configured to control a plurality of memory devices 200 independently.

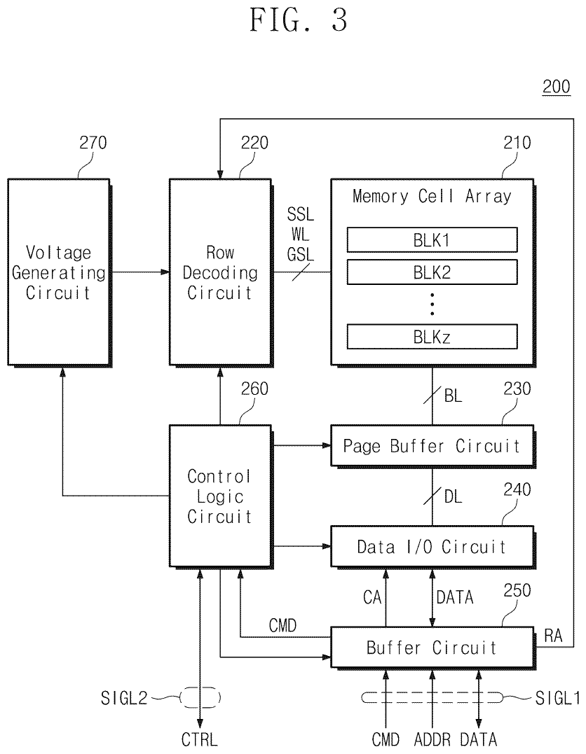

FIG. 3 illustrates a memory device according to some example embodiments. Referring to FIGS. 1 and 3, the memory device 200 may include a memory cell array 210, a row decoding circuit 220, a page buffer circuit 230, a data input/output circuit 240, a buffer circuit 250, a control logic circuit 260, and a voltage generating circuit 270. In some example embodiments, the memory device 200 may be a NAND flash memory. However, example embodiments are not limited thereto, and, in some example embodiments the memory device 200 may be one of various different non-volatile memory devices 200.

The memory cell array 210 includes a plurality of memory blocks BLK1 to BLKz. Each of the plurality of memory blocks BLK1 to BLKz may include a plurality of cell strings. Each of the plurality of cell strings may include a plurality of cell transistors stacked in a direction perpendicular to a substrate. The plurality of cell transistors may be connected in series between bit lines BL and a common source line. The plurality of cell transistors may be connected to string selection lines SSL, word lines WL, and ground selection lines GSL.

The row decoding circuit 220 may be connected to the memory cell array 210 through the string selection lines SSL, the word lines WL, and the ground selection lines GSL. The row decoding circuit 220 may operate under control of the control logic circuit 260. For example, under control of the control logic circuit 260, the row decoding circuit 220 may decode a row address RA received from the buffer circuit 250. In some example embodiments, based on a decoding result, the row decoding circuit 220 may control and/or drive the string selection lines SSL, the word lines WL, and the ground selection lines GSL or may control voltages to be applied to the string selection lines SSL, the word lines WL, and the ground selection lines GSL.

The page buffer circuit 230 may be connected to the memory cell array 210 through the bit lines BL. The page buffer circuit 230 may be connected to the data input/output circuit 240 through a plurality of data lines DL. The page buffer circuit 230 may operate under control of the control logic circuit 260. For example, in the program operation of the memory device 200, the page buffer circuit 230 may store data to be programmed in the memory cell array 210 under control of the control logic circuit 260. In the read operation of the memory device 200, the page buffer circuit 230 may sense voltages of the plurality of bit lines BL and may store the sensed voltages as read data.

The data input/output circuit 240 may be connected to the page buffer circuit 230 through the plurality of data lines DL. The data input/output circuit 240 may receive a column address CA from the buffer circuit 250. The data input/output circuit 240 may transmit and/or send the data read by the page buffer circuit 230 to the buffer circuit 250 depending on the column address CA. The data input/output circuit 240 may transmit and/or send the data received from the buffer circuit 250 to the page buffer circuit 230, based on the column address CA.

The buffer circuit 250 may receive a command CMD and an address ADDR from an external device (e.g., a controller) through first signal lines SIGL1 and may exchange data “DATA” with the external device (e.g., a controller) through the first signal lines SIGL1. In some example embodiments, the first signal lines SIGL1 may include data signal lines (e.g., DQ lines) and a data strobe signal line (e.g., a DQS line).

The buffer circuit 250 may operate under control of the control logic circuit 260. For example, the control logic circuit 260 may exchange a control signal CTRL with the external device (e.g., a controller) through second signal lines SIGL2. The control logic circuit 260 may control the buffer circuit 250 based on the control signal CTRL such that the buffer circuit 250 routes the command CMD, the address ADDR, and the data “DATA”. Under control of the control logic circuit 260, the buffer circuit 250 may classify signals received through the first signal lines SIGL1 as the command CMD or the address ADDR. The buffer circuit 250 may transfer the command CMD to the control logic circuit 260. The buffer circuit 250 may transfer the row address RA of the address ADDR to the row decoding circuit 220 and may transfer the column address CA of the address ADDR to the data input/output circuit 240. The buffer circuit 250 may exchange the data “DATA” with the data input/output circuit 240.

The control logic circuit 260 may decode the command CMD received from the buffer circuit 250 and may control the memory device 200 or various components of the memory device 200 based on a decoding result.

In some example embodiments, under control of the control logic circuit 260, the voltage generating circuit 270 may generate various operating voltages which are used in the memory device 200. In some example embodiments, the operating voltages may include various voltages such as program voltages, pass voltages, selection read voltages, non-selection read voltages, erase voltages, and/or verify voltages, but example embodiments are not limited thereto. Below, various voltages which are used to describe some example embodiments of the present inventive concepts may be included in the operating voltages generated by the voltage generating circuit 270.

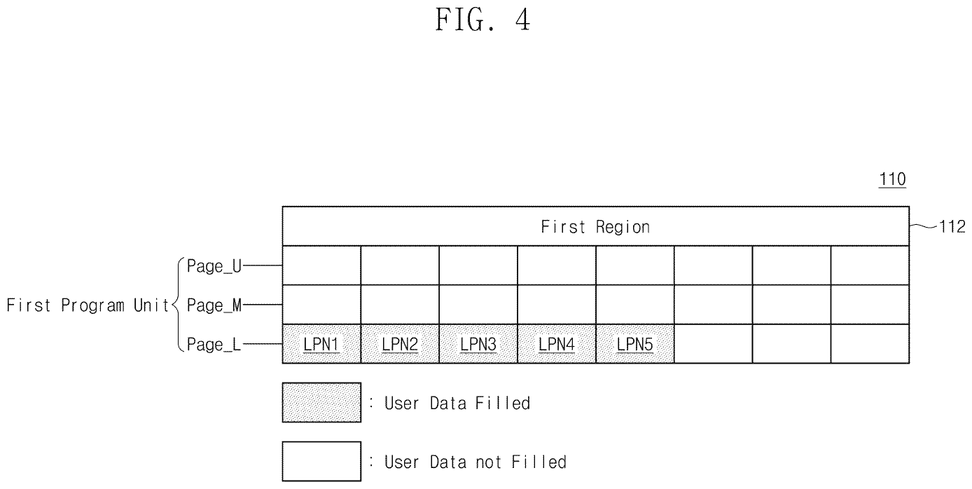

FIG. 4 illustrates a state of a buffer memory before a memory controller receives a flush request, according to some example embodiments. Referring to FIGS. 1 and 4, the buffer memory 110 may include the first region 112. Some example embodiments are described with reference to the first region 112 as being the TLC region corresponding to the TLC memory block, but this is provided as an example. The scope of the present inventive concepts are not limited thereto.

In some example embodiments, the size of the first region 112 may be implemented to be identical to the size of a first program unit. The first program unit may include a lower (L) page Page_L, a middle (M) page Page_M, and an upper (U) page Page_U. Below, for brevity of drawing, the description according to some example embodiments will be given as eight logical page numbers are allocated for each of the L page Page_L, the M page Page_M, and the U page Page_U, but this is provided as an example, and example embodiments are not limited thereto.

According to some example embodiments, before the flush request is received from the host, the memory controller 100 may receive first user data from the host. The memory controller 100 may buffer the first user data in the buffer memory 110. For example, the memory controller 100 may buffer the first user data in the first region 112 of the buffer memory 110. For example, the first user data may be data to which first to fifth logical page numbers LPN1 to LPN5 are allocated. For example, the size of the first user data may be a size allocated to a logical address which the first to fifth logical page numbers LPN1 to LPN5 indicate.

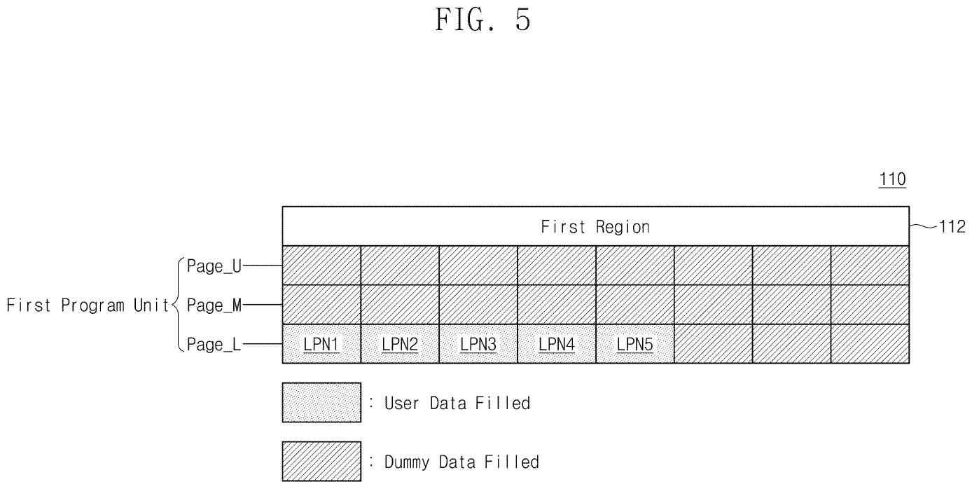

The memory controller 100 may receive the flush request from the host in a state where the first user data to which the first to fifth logical page numbers LPN1 to LPN5 are allocated are buffered in the buffer memory 110. An operation of the buffer memory 110 when the flush request is received from the host according to some example embodiments will be described in detail with reference to FIGS. 5 to 7B.

FIG. 5 is a diagram for describing a method in which a memory controller operates when a flush request is received, according to some example embodiments. Referring to FIGS. 1, 4, and 5, in response to receiving the flush request from the host, the memory controller 100 may pad a portion of the first region 112 of the buffer memory 110, in which first user data are not filled, with dummy data. Accordingly, the first region 112 may be filled with the first user data and the dummy data. For example, in the first region 112, padded data may be generated as the first user data are padded with the dummy data, and the padded data may complete the first program unit.

The memory controller 100 according to some example embodiments may program the padded data in the memory device 200 as the first program unit is completed. In some example embodiments, the dummy data may be excessively generated in the process and/or operation of processing the flush request received from the host. As the program operation of the dummy data are excessively performed, the performance and lifetime of the memory device 200 may be reduced.

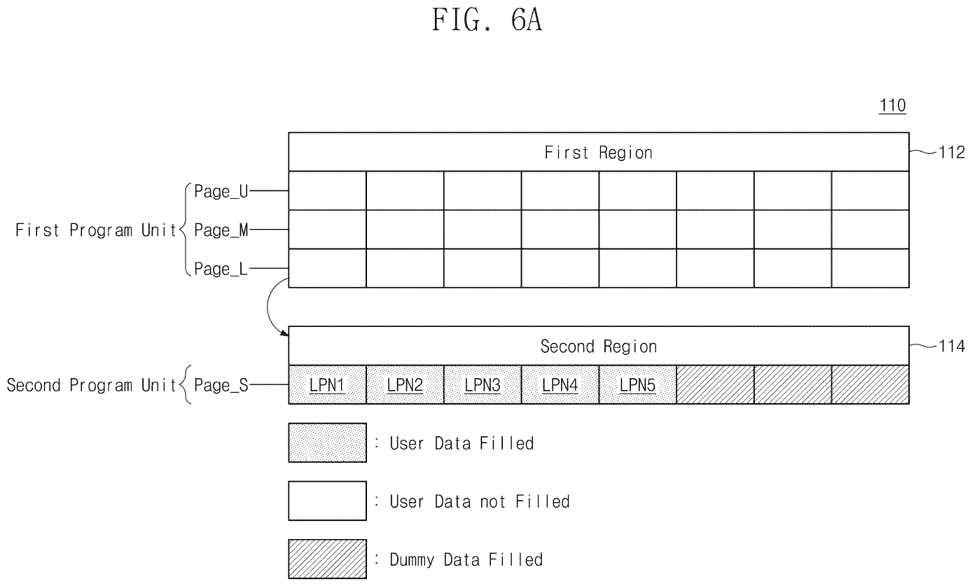

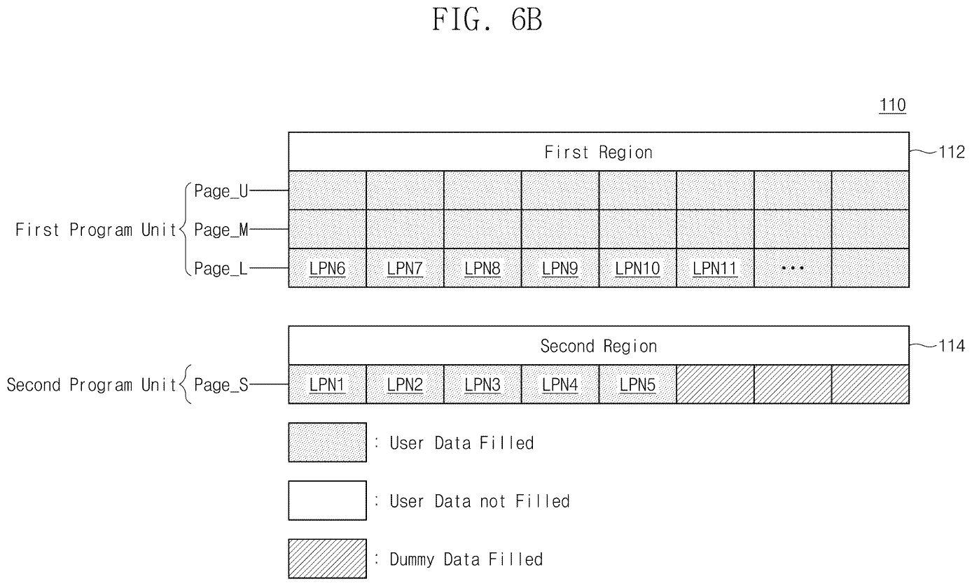

FIGS. 6A and 6B are diagrams for describing a method in which a memory controller operates when a flush request is received, according to some example embodiments. Referring to FIGS. 1, 4, 6A, and 6B, the buffer memory 110 may include the second region 114. The example embodiments are described with reference to the second region 114 being the SLC region corresponding to the SLC memory block, but this is provided as an example, but example embodiments of the present inventive concepts are not limited thereto.

The size of the second region 114 may be implemented to be identical to the size of a second program unit. The second program unit may include an S page Page_S. Below, for brevity of drawing, the description will be given as eight logical page numbers are allocated to the S page Page_S, but example embodiments of the present inventive concepts are not limited thereto.

Referring to FIGS. 1, 4, and 6A, in response to receiving the flush request from the host, the memory controller 100 may move the first user data buffered in the first region 112 of the buffer memory 110 to the second region 114. In some example embodiments, the memory controller 100 may pad a portion of the second region 114 of the buffer memory 110, in which the first user data are not filled, with dummy data. Accordingly, the second region 114 may be filled with the first user data and the dummy data. For example, in the second region 114, padded data may be generated as the first user data are padded with the dummy data, and the padded data may complete the second program unit. In some example embodiments, the above issue that the dummy data are excessively generated in the process of processing the flush request received from the host may be prevented, mitigated and/or solved, and the performance and/or lifetime of the memory device may be improved.

The memory controller 100 according to some example embodiments may program the padded data in the memory device 200 as the second program unit is completed. For example, the memory controller 100 may program the padded data of the second region 114 in the second memory region 214 of the memory device 200. In some example embodiments, after the padded data are completely programmed in the second memory region 214, the memory controller 100 may release the first user data buffered in the buffer memory 110. For example, the memory controller 100 may release the cache data of the buffer memory 110 in response to the first user data being completely programmed in the second memory region 214.

Referring to FIGS. 1, 4, 6A, and 6B, after releasing the first user data buffered in the buffer memory 110, the memory controller 100 may receive the second user data from the host. The memory controller 100 may buffer the second user data in the buffer memory 110. For example, the memory controller 100 may buffer the second user data in the first region 112 of the buffer memory 110. For example, the second user data may be data to which a sixth logical page number LPN6 and subsequent logical page numbers are allocated.

As the second user data are continuously received from the host, the first program unit of the first region 112 may be completed by the second user data. For example, the size of the second user data may be identical to the size of the first program unit. According to some example embodiments, the description is given as the size of the second user data is identical to the size of the first program unit to describe how the memory controller 100 operates when the first program unit is completed by subsequent data received from the host after the first user data are programmed in the memory device 200, and this is provided as an example, but example embodiments of the present inventive concepts are not limited thereto.

The memory controller 100 according to some example embodiments may program the second user data in the memory device 200 as the first program unit is completed. For example, the memory controller 100 may program the second user data of the first region 112 in the first memory region 212 of the memory device 200.

In some example embodiments, because the first user data and the second user data are respectively stored in different memory regions of the memory device 200, the data sequentiality (e.g., order) of the first user data and the second user data may be damaged. For example, the memory controller 100 may receive the sequential read request for the first user data and the second user data from the host. In some example embodiments, the performance of processing the sequential read request for the first user data and the second user data in which the data sequentiality (e.g., order) is damaged may be reduced.

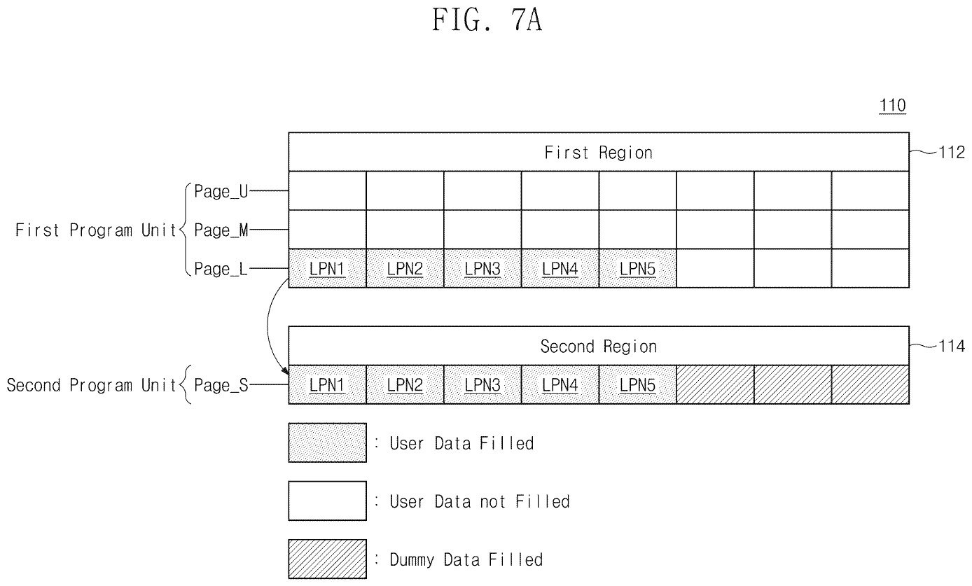

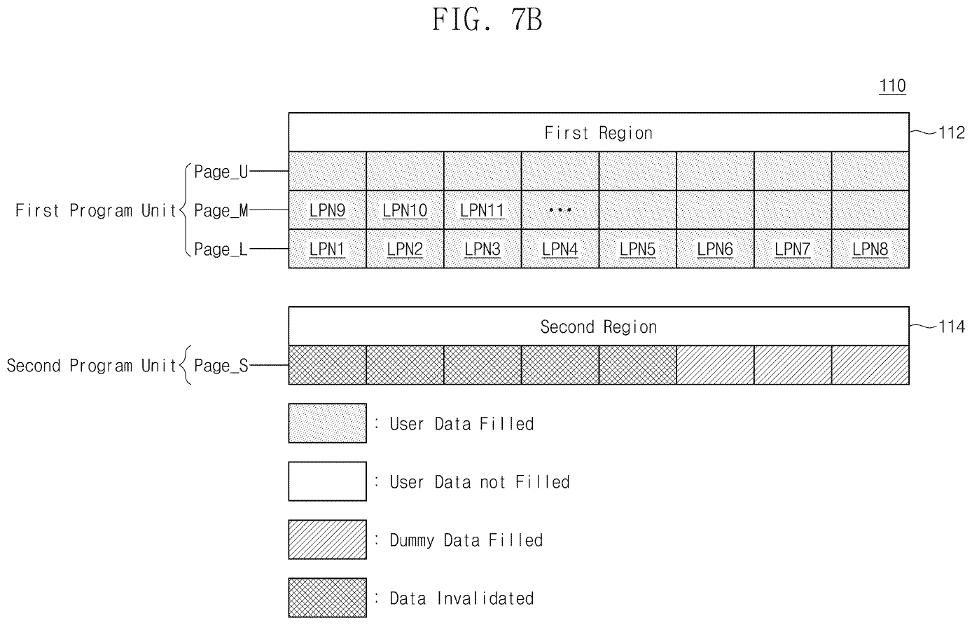

FIGS. 7A and 7B are diagrams for describing a method in which a memory controller operates when a flush request is received, according some example embodiments. Referring to FIGS. 1, 4, 7A, and 7B, the buffer memory 110 may include the second region 114. The second region 114 of FIGS. 7A and 7B is configured to be identical to the second region 114 of FIGS. 6A and 6B. Thus, additional description will be omitted to avoid redundancy.

Referring to FIGS. 1, 4, and 7A, in response to receiving the flush request from the host, the memory controller 100 may duplicate the first user data buffered in the first region 112 of the buffer memory 110 to the second region 114. In some example embodiments, the memory controller 100 may pad a portion of the second region 114 of the buffer memory 110, in which the first user data are not filled, with dummy data. Accordingly, the second region 114 may be filled with the first user data and the dummy data. For example, in the second region 114, padded data may be generated as the first user data are padded with the dummy data, and the padded data may complete the second program unit. In some example embodiments, the above issue that the dummy data are excessively generated in the process of processing the flush request received from the host may be prevented, reduced, mitigated and/or solved.

The memory controller 100 according to some example embodiments may program the padded data in the memory device 200 as the second program unit is completed. For example, the memory controller 100 may program the padded data of the second region 114 in the second memory region 214 of the memory device 200. In some example embodiments, after the first user data are completely programmed in the second memory region 214, the memory controller 100 may not release the first user data buffered in the buffer memory 110. For example, the memory controller 100 may not release the cache data of the buffer memory 110 even after the first user data are completely programmed in the second memory region 214.

Referring to FIGS. 1, 4, 7A, and 7B, after the program operation for the first user data is completed, the memory controller 100 may receive the second user data from the host. The memory controller 100 may buffer the second user data in the buffer memory 110. For example, the memory controller 100 may buffer the second user data in the first region 112 of the buffer memory 110. For example, the second user data may be data to which a sixth logical page number LPN6 and subsequent logical page numbers are allocated.

As the second user data are continuously received from the host, the first program unit of the first region 112 may be completed by the first user data previously buffered and the second user data subsequently buffered after the flush request is received. For example, a size obtained by adding the size of the first user data and the size of the second user data may be identical to the size of the first program unit. According to some example embodiments, the description is given as the size of the second user data is identical to the size of the first program unit to describe how the memory controller 100 operates when the first program unit is completed by subsequent data received from the host after the first user data are programmed in the memory device 200, and this is provided as an example, but example embodiments of the present inventive concepts are not limited thereto.

The memory controller 100 according to some example embodiments may program the first user data and the second user data in the memory device 200 as the first program unit is completed. For example, the memory controller 100 may program the first user data and the second user data of the first region 112 in the first memory region 212 of the memory device 200. In some example embodiments, after the first user data and the second user data are completely programmed in the first memory region 212, the memory controller 100 may release the first user data and the second user data buffered in the buffer memory 110. For example, after the first user data and the second user data are completely programmed in the first memory region 212, the memory controller 100 may release the cache data of the buffer memory 110. Accordingly, the first user data programmed in the second memory region 214 of the memory device 200 may be invalidated.

In some example embodiments, because the first user data and the second user data are stored in the same memory regions of the memory device 200, the data sequentiality (e.g., order) of the first user data and the second user data may be guaranteed. For example, the memory controller 100 may receive the sequential read request for the first user data and the second user data from the host. In some example embodiments, the performance of processing the sequential read request for the first user data and the second user data in which the data sequentiality (e.g., order) is guaranteed may be improved.

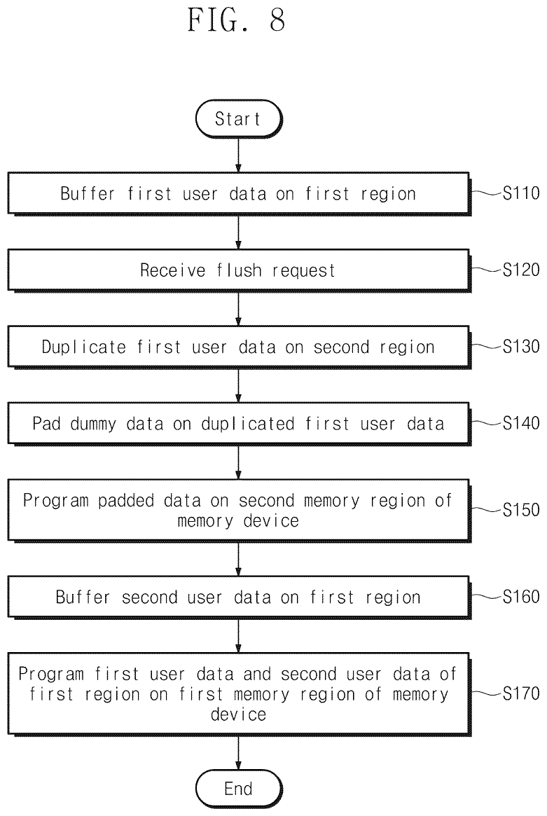

FIG. 8 illustrates an operating method of a memory controller according to some example embodiments. Referring to FIGS. 1, 4, 7A, 7B, and 8, in operation S110, the storage device 10 may buffer the first user data in the first region 112. For example, the memory controller 100 of the storage device 10 may buffer the first user data received from the host in the first region 112 of the buffer memory 110.

In operation S120, the storage device 10 may receive the flush request. For example, the memory controller 100 of the storage device 10 may receive the flush request from the host in a state where the first program unit is not yet completed.

In operation S130, the storage device 10 may duplicate the first user data to the second region 114. For example, the memory controller 100 of the storage device 10 may duplicate the first user data of the first region 112 of the buffer memory 110 to the second region 114 of the buffer memory 110.

In operation S140, the storage device 10 may pad the duplicated first user data with dummy data. For example, the memory controller 100 of the storage device 10 may generate padded data by padding the first user data duplicated to the second region 114 of the buffer memory 110 with dummy data, for example, may complete the second program unit.

In operation S150, the storage device 10 may program the padded data in the second memory region 214 of the memory device 200. For example, the memory controller 100 of the storage device 10 may program the padded data of the second region 114 of the buffer memory 110 in the second memory region 214 of the memory device 200 corresponding to the second region 114.

In operation S160, the storage device 10 may buffer the second user data in the first region 112. For example, the memory controller 100 of the storage device 10 may buffer the second user data received from the host in the first region 112 of the buffer memory 110. In some example embodiments, the first program unit of the first region 112 may be completed by the first user data and the second user data.

In operation S170, the storage device 10 may program the first user data and the second user data of the first region 112 in the first memory region 212 of the memory device 200. For example, the memory controller 100 of the storage device 10 may program the first user data and the second user data of the first region 112 of the buffer memory 110 in the first memory region 212 of the memory device 200 corresponding to the first region 112.

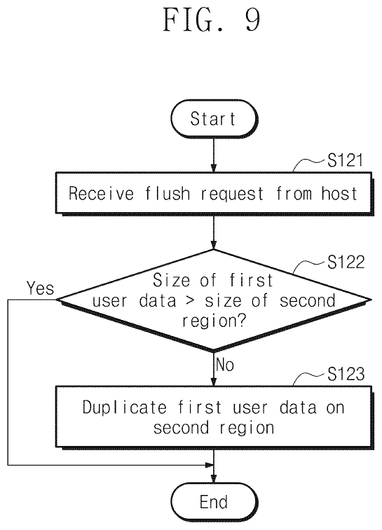

FIG. 9 illustrates an operation in which a memory controller receives a flush request, in detail according to some example embodiments. Referring to FIGS. 1, 4, 7A, 7B, 8, and 9, in operation S121, the storage device 10 may receive the flush request from the host. For example, the memory controller 100 of the storage device 10 may receive the flush request from the host in a state where the first program unit is not completed.

In operation S122, the storage device 10 may compare the size of the first user data with the size of the second region 114. For example, the memory controller 100 of the storage device 10 may determine the size of the first user data buffered in the first region 112 of the buffer memory 110 is greater than the size of the second region 114 of the buffer memory 110.

For example, when the size of the first user data is greater than the size of the second region 114, the memory controller 100 may perform the operation according to some example embodiments described with reference to FIG. 5. For example, the memory controller 100 may pad a portion of the first region 112 of the buffer memory 110, in which the first user data are not filled, with dummy data.

For example, when the size of the first user data is identical to the size of the second region 114 or when the size of the first user data is smaller than the size of the second region 114, the storage device 10 may proceed to operation S123 and may perform an operation to be described later according to some example embodiments. In operation S123, the storage device 10 may duplicate the first user data to the second region 114. For example, operation S123 may correspond to operation S130 of FIG. 8.

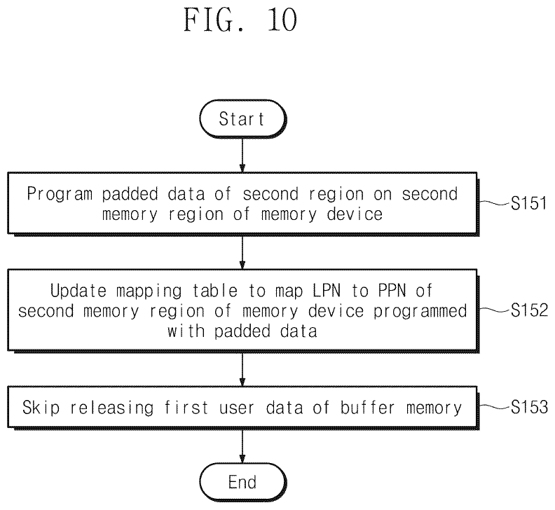

FIG. 10 illustrates an operation in which a memory controller programs padded data in a memory device, in detail according to some example embodiments. Referring to FIGS. 1, 4, 7A, 7B, 8, and 10, in operation S151, the storage device 10 may program the padded data of the second region 114 in the second memory region 214 of the memory device 200. For example, the memory controller 100 of the storage device 10 may program the padded data of the second region 114 of the buffer memory 110 in the second memory region 214 of the memory device 200 corresponding to the second region 114.

In operation S152, the storage device 10 may update the mapping table such that a logical page number (LPN) is mapped to a physical page number (PPN) of the second memory region 214 of the memory device 200, at which the padded data are programmed. For example, the memory controller 100 of the storage device 10 may perform a first update operation on the mapping table such that a logical address received from the host is mapped to a physical address of the second memory region 214, at which the padded data are programmed.

In operation S153, the storage device 10 may skip and/or omit the release operation associated with the first user data of the buffer memory 110. For example, even after the padded data are completely programmed in the second memory region 214 of the memory device 200, the memory controller 100 of the storage device 10 may not perform the release operation on the first user data.

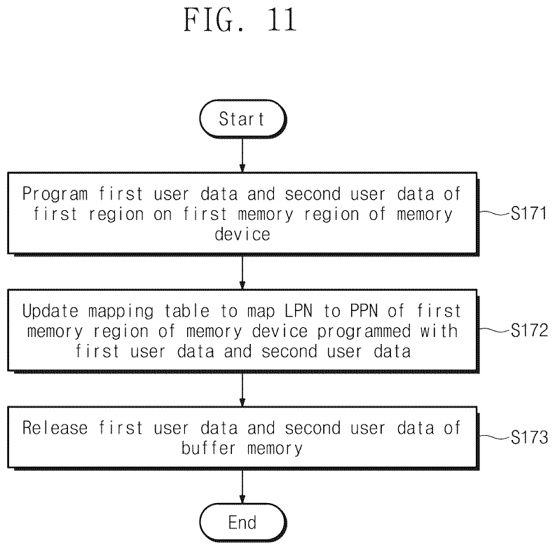

FIG. 11 illustrates an operation in which a memory controller programs first user data and second user data in a memory device, in detail according to some example embodiments. Referring to FIGS. 1, 4, 7A, 7B, 8, and 11, in operation S171, the storage device 10 may program the first user data and the second user data of the first region 112 in the first memory region 212 of the memory device 200. For example, the memory controller 100 of the storage device 10 may program the first user data and the second user data of the first region 112 of the buffer memory 110 in the first memory region 212 of the memory device 200 corresponding to the first region 112.

In operation S172, the storage device 10 may update the mapping table such that a logical page number (LPN) is mapped to a physical page number (PPN) of the first memory region 212 of the memory device 200, at which the first user data and the second user data are programmed. For example, the memory controller 100 of the storage device 10 may perform a second update operation on the mapping table such that a logical address received from the host is mapped to a physical address of the first memory region 212, at which the first user data and the second user data are programmed.

In operation S173, the storage device 10 may perform the release operation associated with the first user data and the second user data of the buffer memory 110. For example, after the first user data and the second user data are completely programmed in the first memory region 212 of the memory device 200, the memory controller 100 of the storage device 10 may perform the release operation associated with the first user data and the first user data.

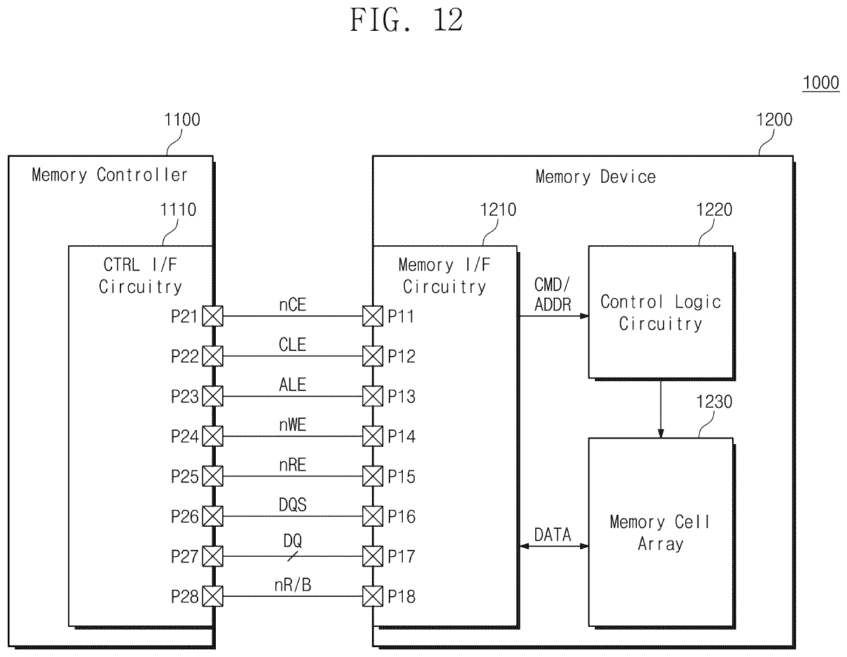

FIG. 12 is a block diagram illustrating a memory system according to some example embodiments. Referring to FIG. 12, the memory system 1000 may include a memory device 1200 and a memory controller 1100.

The memory device 1200 may include first to eighth pins P11 to P18, a memory interface circuitry 1210, a control logic circuitry 1220, and a memory cell array 1230.

The memory interface circuitry 1210 may receive a chip enable signal nCE from the memory controller 1100 through the first pin P11. The memory interface circuitry 1210 may transmit and/or send and receive signals to and from the memory controller 1100 through the second to eighth pins P12 to P18 in response to the chip enable signal nCE. For example, when the chip enable signal nCE is in an enable state (e.g., a low level), the memory interface circuitry 1210 may transmit and/or send and receive signals to and from the memory controller 1100 through the second to eighth pins P12 to P18.

The memory interface circuitry 1210 may receive a command latch enable signal CLE, an address latch enable signal ALE, and a write enable signal nWE from the memory controller 1100 through the second to fourth pins P12 to P14. The memory interface circuitry 1210 may receive a data signal DQ from the memory controller 1100 through the seventh pin P17 or transmit and/or the data signal DQ to the memory controller 1100. A command CMD, an address ADDR, and data may be transmitted and/or sent via the data signal DQ. For example, the data signal DQ may be transmitted and/or sent through a plurality of data signal lines. In some example embodiments, the seventh pin P17 may include a plurality of pins respectively corresponding to a plurality of data signals DQ(s).

The memory interface circuitry 1210 may obtain the command CMD from the data signal DQ, which is received in an enable section (e.g., a high-level state) of the command latch enable signal CLE based on toggle time points of the write enable signal nWE. The memory interface circuitry 1210 may obtain the address ADDR from the data signal DQ, which is received in an enable section (e.g., a high-level state) of the address latch enable signal ALE based on the toggle time points of the write enable signal nWE.

In some example embodiments, the write enable signal nWE may be maintained at a static state (e.g., a high level or a low level) and toggle between the high level and the low level. For example, the write enable signal nWE may toggle in a section in which the command CMD or the address ADDR is transmitted and/or sent. Thus, the memory interface circuitry 1210 may obtain the command CMD or the address ADDR based on toggle time points of the write enable signal nWE.

The memory interface circuitry 1210 may receive a read enable signal nRE from the memory controller 1100 through the fifth pin P15. The memory interface circuitry 1210 may receive a data strobe signal DQS from the memory controller 1100 through the sixth pin P16 or transmit and/or send the data strobe signal DQS to the memory controller 1100.

In a data (DATA) output operation of the memory device 1200, the memory interface circuitry 1210 may receive the read enable signal nRE, which toggles through the fifth pin P15, before outputting the data DATA. The memory interface circuitry 1210 may generate the data strobe signal DQS, which toggles based on the toggling of the read enable signal nRE. For example, the memory interface circuitry 1210 may generate a data strobe signal DQS, which starts toggling after a predetermined or alternatively, a desired delay (e.g., tDQSRE), based on a toggling start time of the read enable signal nRE. The memory interface circuitry 1210 may transmit and/or send the data signal DQ including the data DATA based on a toggle time point of the data strobe signal DQS. Thus, the data DATA may be aligned with the toggle time point of the data strobe signal DQS and transmitted and/or sent to the memory controller 1100.

In a data (DATA) input operation of the memory device 1200, when the data signal DQ including the data DATA is received from the memory controller 1100, the memory interface circuitry 1210 may receive the data strobe signal DQS, which toggles, along with the data DATA from the memory controller 1100. The memory interface circuitry 1210 may obtain the data DATA from the data signal DQ based on toggle time points of the data strobe signal DQS. For example, the memory interface circuitry 1210 may sample the data signal DQ at rising and falling edges of the data strobe signal DQS and obtain the data DATA.

The memory interface circuitry 1210 may transmit and/or send a ready/busy output signal nR/B to the memory controller 1100 through the eighth pin P18. The memory interface circuitry 1210 may transmit and/or send state information of the memory device 1200 through the ready/busy output signal nR/B to the memory controller 1100. For example, when the memory device 1200 is in a busy state (e.g., when operations are being performed in the memory device 1200), the memory interface circuitry 1210 may transmit and/or send a ready/busy output signal nR/B indicating the busy state to the memory controller 1100. For example, when the memory device 1200 is in a ready state (e.g., when operations are not performed or completed in the memory device 1200), the memory interface circuitry 1210 may transmit and/or send a ready/busy output signal nR/B indicating the ready state to the memory controller 1100. For example, while the memory device 1200 is reading data DATA from the memory cell array 1230 in response to a page read command, the memory interface circuitry 1210 may transmit and/or send a ready/busy output signal nR/B indicating a busy state (e.g., a low level) to the memory controller 1100. For example, while the memory device 1200 is programming data DATA to the memory cell array 1230 in response to a program command, the memory interface circuitry 1210 may transmit and/or send a ready/busy output signal nR/B indicating the busy state to the memory controller 1100.

The control logic circuitry 1220 may control all operations of the memory device 1200. The control logic circuitry 1220 may receive the command/address CMD/ADDR obtained from the memory interface circuitry 1210. The control logic circuitry 1220 may generate control signals for controlling other components of the memory device 1200 in response to the received command/address CMD/ADDR. For example, the control logic circuitry 1220 may generate various control signals for programming data DATA to the memory cell array 1230 or reading the data DATA from the memory cell array 1230.

The memory cell array 1230 may store the data DATA obtained from the memory interface circuitry 1210, via the control of the control logic circuitry 1220. The memory cell array 1230 may output the stored data DATA to the memory interface circuitry 1210 via the control of the control logic circuitry 1220.

The memory cell array 1230 may include a plurality of memory cells. For example, the plurality of memory cells may be flash memory cells. However, example embodiments of the present inventive concepts are not limited thereto, and, in some example embodiments, the memory cells may be RRAM cells, FRAM cells, PRAM cells, thyristor RAM (TRAM) cells, and/or MRAM cells. Hereinafter, some example embodiments in which the memory cells are NAND flash memory cells will mainly be described.

The memory controller 1100 may include first to eighth pins P21 to P28 and a controller interface circuitry 1110. The first to eighth pins P21 to P28 may respectively correspond to the first to eighth pins P11 to P18 of the memory device 1200.

The controller interface circuitry 1110 may transmit and/or send a chip enable signal nCE to the memory device 1200 through the first pin P21. The controller interface circuitry 1110 may transmit and/or send and receive signals to and from the memory device 1200, which is selected by the chip enable signal nCE, through the second to eighth pins P22 to P28.

The controller interface circuitry 1110 may transmit and/or send the command latch enable signal CLE, the address latch enable signal ALE, and the write enable signal nWE to the memory device 1200 through the second to fourth pins P22 to P24. The controller interface circuitry 1110 may transmit and/or send or receive the data signal DQ to and from the memory device 1200 through the seventh pin P27.

The controller interface circuitry 1110 may transmit and/or send the data signal DQ including the command CMD or the address ADDR to the memory device 1200 along with the write enable signal nWE, which toggles. The controller interface circuitry 1110 may transmit and/or send the data signal DQ including the command CMD to the memory device 1200 by transmitting and/or sending a command latch enable signal CLE having an enable state. In some example embodiments, the controller interface circuitry 1110 may transmit and/or send the data signal DQ including the address ADDR to the memory device 1200 by transmitting and/or sending an address latch enable signal ALE having an enable state.

The controller interface circuitry 1110 may transmit and/or send the read enable signal nRE to the memory device 1200 through the fifth pin P25. The controller interface circuitry 1110 may receive or transmit and/or send the data strobe signal DQS from or to the memory device 1200 through the sixth pin P26.

In a data (DATA) output operation of the memory device 1200, the controller interface circuitry 1110 may generate a read enable signal nRE, which toggles, and transmits and/or sends the read enable signal nRE to the memory device 1200. For example, before outputting data DATA, the controller interface circuitry 1110 may generate a read enable signal nRE, which is changed from a static state (e.g., a high level or a low level) to a toggling state. Thus, the memory device 1200 may generate a data strobe signal DQS, which toggles, based on the read enable signal nRE. The controller interface circuitry 1110 may receive the data signal DQ including the data DATA along with the data strobe signal DQS, which toggles, from the memory device 1200. The controller interface circuitry 1110 may obtain the data DATA from the data signal DQ based on a toggle time point of the data strobe signal DQS.

In a data (DATA) input operation of the memory device 1200, the controller interface circuitry 1110 may generate a data strobe signal DQS, which toggles. For example, before transmitting and/or sending data DATA, the controller interface circuitry 1110 may generate a data strobe signal DQS, which is changed from a static state (e.g., a high level or a low level) to a toggling state. The controller interface circuitry 1110 may transmit and/or send the data signal DQ including the data DATA to the memory device 1200 based on toggle time points of the data strobe signal DQS.

The controller interface circuitry 1110 may receive a ready/busy output signal nR/B from the memory device 1200 through the eighth pin P28. The controller interface circuitry 1110 may determine state information of the memory device 1200 based on the ready/busy output signal nR/B.

In some example embodiments, the memory controller 1100 may be the memory controller 100 described with reference to FIGS. 1 to 11.

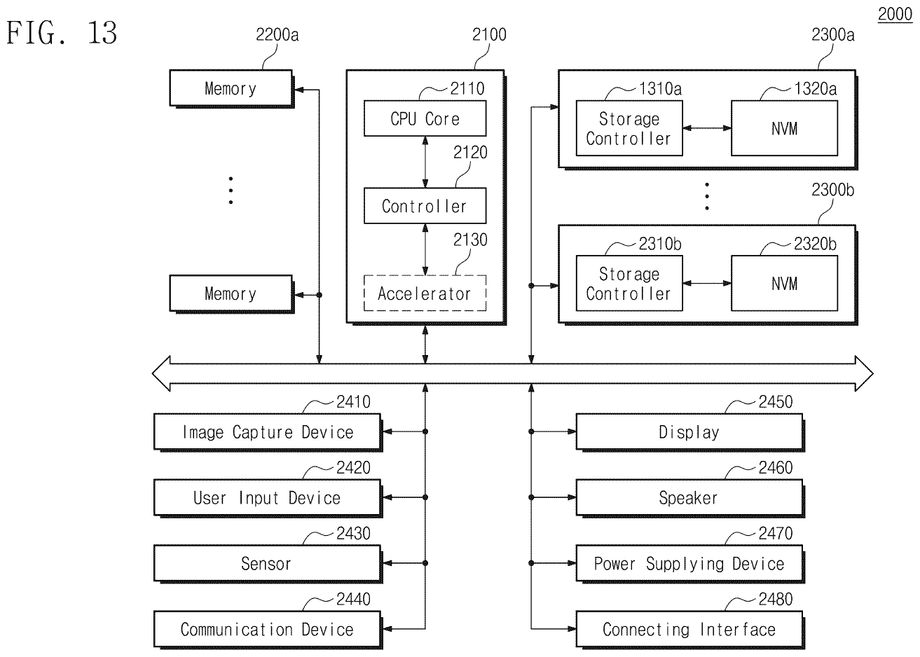

FIG. 13 is a diagram illustrating a system to which a storage device according to some example embodiments is applied. The system 2000 of FIG. 13 may basically be a mobile system, such as a portable communication terminal (e.g., a mobile phone), a smartphone, a tablet personal computer (PC), a wearable device, a healthcare device, and/or an Internet of things (IOT) device. However, the system 2000 of FIG. 13 is not necessarily limited to the mobile system and, in some example embodiments, the system 2000 of FIG. 13 may be a PC, a laptop computer, a server, a media player, and/or an automotive device (e.g., a navigation device).

Referring to FIG. 13, the system 2000 may include a main processor 2100, memories (e.g., 2200a and 2200b), and storage devices (e.g., 2300a and 2300b). In some example embodiments, the system 2000 may include at least one of an image capturing device 2410, a user input device 2420, a sensor 2430, a communication device 2440, a display 2450, a speaker 2460, a power supplying device 2470, and a connecting interface 2480.

The main processor 2100 may control all operations of the system 2000, for example, operations of other components included in the system 2000. The main processor 2100 may be implemented as a general-purpose processor, a dedicated processor, and/or an application processor.

The main processor 2100 may include at least one CPU core 2110 and further include a controller 2120 configured to control the memories 2200a and 2200b and/or the storage devices 2300a and 2300b. In some example embodiments, the main processor 2100 may further include an accelerator 2130, which is a dedicated circuit for a high-speed data operation, such as an artificial intelligence (AI) data operation. The accelerator 2130 may include a graphics processing unit (GPU), a neural processing unit (NPU) and/or a data processing unit (DPU) and may be implemented as a chip that is physically separate from the other components of the main processor 2100.

The memories 2200a and 2200b may be used as main memory devices of the system 2000. Although each of the memories 2200a and 2200b may include a volatile memory, such as static random access memory (SRAM) and/or dynamic RAM (DRAM), each of the memories 2200a and 2200b may include non-volatile memory, such as a flash memory, phase-change RAM (PRAM) and/or resistive RAM (RRAM). The memories 2200a and 2200b may be implemented in the same package as the main processor 2100.

The storage devices 2300a and 2300b may serve as non-volatile storage devices configured to store data regardless of whether power is supplied thereto, and have larger storage capacity than the memories 2200a and 2200b. The storage devices 2300a and 2300b may respectively include storage controllers (STRG CTRL) 2310a and 2310b and NVMs (Non-Volatile Memories) 2320a and 2320b configured to store data via the control of the storage controllers 2310a and 2310b. Although the NVMs 2320a and 2320b may include flash memories having a two-dimensional (2D) structure or a three-dimensional (3D) V-NAND structure, example embodiments are not limited thereto, and, in some example embodiments, the NVMs 2320a and 2320b may include other types of NVMs, such as PRAM and/or RRAM.

The storage devices 2300a and 2300b may be physically separated from the main processor 2100 and included in the system 2000 or implemented in the same package as the main processor 2100. In some example embodiments, the storage devices 2300a and 2300b may have types of solid-state devices (SSDs) or memory cards and be removably combined with other components of the system 2000 through an interface, such as the connecting interface 2480 that will be described below. The storage devices 2300a and 2300b may be devices to which a standard protocol, such as a universal flash storage (UFS), an embedded multi-media card (eMMC), and/or a non-volatile memory express (NVMe), is applied, but example embodiments are not limited thereto.

The image capturing device 2410 may capture still images and/or moving images. The image capturing device 2410 may include a camera, a camcorder, and/or a webcam.

The user input device 2420 may receive various types of data input by a user of the system 2000 and include a touch pad, a keypad, a keyboard, a mouse, and/or a microphone.

The sensor 2430 may detect various types of physical quantities, which may be obtained from the outside of the system 2000, and convert the detected physical quantities into electric signals. The sensor 2430 may include a temperature sensor, a pressure sensor, an illuminance sensor, a position sensor, an acceleration sensor, a biosensor, and/or a gyroscope sensor.

The communication device 2440 may transmit and/or send and receive signals between other devices outside the system 2000 according to various communication protocols. The communication device 2440 may include an antenna, a transceiver, and/or a modem.

The display 2450 and the speaker 2460 may serve as output devices configured to respectively output visual information and auditory information to the user of the system 2000.

The power supplying device 2470 may appropriately convert power supplied from a battery (not shown) embedded in the system 2000 and/or an external power source, and supply the converted power to each of components of the system 2000.

The connecting interface 2480 may provide connection between the system 2000 and an external device, which is connected to the system 2000 and capable of transmitting and/or sending and receiving data to and from the system 2000. The connecting interface 2480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

In some example embodiments, the storage controllers 2310a and 2310b of the storage devices 2300a and 2300b of FIG. 13 may be the memory controller 100 described with reference to FIGS. 1 to 11.

According to some example embodiments of the present inventive concepts, a memory controller having improved performance is provided. In some example embodiments, the memory controller according to the present inventive concepts may store user data in a memory device in response to receiving a flush request, and thus, the sequentiality (e.g., order) of data may be guaranteed.

As described herein, any devices, electronic devices, modules, units, and/or portions thereof according to any of the example embodiments, and/or portions thereof may include, may be included in, and/or may be implemented by one or more instances of processing circuitry such as hardware including logic circuits; a hardware/software combination such as a processor executing software; or a combination thereof. For example, the processing circuity more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a solid state drive (SSD), storing a program of instructions, and a processor (e.g., CPU) configured to execute the program of instructions to implement the functionality and/or methods performed by some or all of any devices, electronic devices, modules, units, and/or portions thereof according to any of the example embodiments.

Any of the memories described herein may be a nonvolatile memory, such as a flash memory, a phase-change random access memory (PRAM), a magneto-resistive RAM (MRAM), a resistive RAM (ReRAM), or a ferro-electric RAM (FRAM), or a volatile memory, such as a static RAM (SRAM), a dynamic RAM (DRAM), or a synchronous DRAM (SDRAM).

Any or all of the elements described with reference to the figures may communicate with any or all other elements described with reference to the figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be encoded in various formats, such as in an analog format and/or in a digital format.

While some example embodiments of the present inventive concepts have been described with reference to some example embodiments thereof, it will be apparent to those of ordinary skill in the art that various changes and modifications may be made thereto without departing from the spirit and scope of the present inventive concepts as set forth in the following claims.

What is claimed is:

1. An operating method of a memory controller, the method comprising:
buffering first user data received from a host in a first region of a buffer memory corresponding to a first memory region of a memory device;
receiving a flush request from the host;
duplicating the first user data in a second region of the buffer memory corresponding to a second memory region of the memory device;
padding, as padded data, the first user data duplicated to the second region with dummy data;
programming the padded data in the second memory region of the memory device;
buffering second user data received from the host in the first region; and
programming, in the first memory region of the memory device, the first user data buffered in the first region and the second user data buffered in the first region.

2. The method of claim 1, wherein
the first memory region is an n-bit multi-level cell (MLC) region,
the second memory region is one of an m-bit MLC region or a single level cell (SLC) region,
“m” is a first natural number greater than 1, and
“n” is a second natural number greater than “m”.

3. The method of claim 2, wherein
a first size of the first region corresponds to a second size of a first page of the first memory region, and
a third size of the second region corresponds to a fourth size of a second page of the second memory region.

4. The method of claim 3, wherein
the programming the padded data in the second memory region includes performing a first update operation on a mapping table, and
the programming the first user data in the first memory region and the second user data in the first memory region includes performing a second update operation on the mapping table.

5. The method of claim 4, wherein the performing the first update operation includes:
updating the mapping table such that a logical page number received from the host is mapped to a physical page number of the second memory region of the memory device where the padded data are programmed.

6. The method of claim 4, wherein the performing the second update operation includes:
updating the mapping table such that a logical page number received from the host is mapped to a physical page number of the first memory region of the memory device where the first user data buffered in the first region and the second user data buffered in the first region are programmed.

7. The method of claim 4, wherein the programming the first user data in the first memory region and the second user data in the first memory region further includes:
releasing the first user data and the second user data buffered in the buffer memory.

8. The method of claim 3, wherein the receiving the flush request includes:
comparing a fifth size of the first user data with the third size of the second region.

9. The method of claim 3, wherein a fifth size of the padded data is identical to the third size of the second region.

10. A memory controller, comprising:
a buffer memory including a first region corresponding to a first memory region of a memory device, and a second region corresponding to a second memory region of the memory device,
the memory controller configured to,
buffer first user data received from a host in the first region;
receive a flush request from the host;
duplicate the first user data to the second region;
pad, as padded data, the first user data duplicated to the second region with dummy data;
program the padded data in the second memory region;
buffer second user data received from the host in the first region; and
program, in the first memory region, the first user data buffered in the first region and the second user data buffered in the first region.

11. The memory controller of claim 10, wherein
the first memory region is an n-bit multi-level cell (MLC) region,
the second memory region is one of an m-bit MLC region or a single level cell (SLC) region,
“m” is a first natural number greater than 1, and
“n” is a second natural number greater than “m”.

12. The memory controller of claim 11, wherein
a first size of the first region corresponds to a second size of a first page of the first memory region, and
a third size of the second region corresponds to a fourth size of a second page of the second memory region.

13. The memory controller of claim 12, wherein the memory controller is configured to:
perform a first update operation on a mapping table in response to the padded data being completely programmed in the second memory region; and
perform a second update operation on the mapping table in response to the first user data and the second user data being completely programmed in the first memory region.

14. The memory controller of claim 13, wherein the first update operation is an operation of updating the mapping table such that a logical page number received from the host is mapped to a physical page number of the second memory region of the memory device where the padded data are programmed.

15. The memory controller of claim 13, wherein the second update operation is an operation of updating the mapping table such that a logical page number received from the host is mapped to a physical page number of the first memory region of the memory device where the first user data buffered in the first region and the second user data buffered in the first region are programmed.

16. The memory controller of claim 13, wherein the memory controller is configured to:
release the first user data and the second user data buffered in the buffer memory in response to the first user data and the second user data being completely programmed in the first memory region.

17. The memory controller of claim 12, wherein the memory controller is configured to:
compare a fifth size of the first user data with the third size of the second region in response to receiving the flush request from the host.

18. The memory controller of claim 12, wherein a fifth size of the padded data is identical to the third size of the second region.

19. A storage device, comprising:
a memory device including a first memory region and a second memory region; and
a memory controller configured to control the memory device, the memory controller including a buffer memory, the buffer memory including a first region corresponding to the first memory region of the memory device and a second region corresponding to the second memory region of the memory device,
the memory controller is configured to,
buffer first user data received from a host in the first region;
receive a flush request from the host;
duplicate the first user data to the second region;
pad, as padded data, the first user data duplicated to the second region with dummy data;
program the padded data in the second memory region;
buffer second user data received from the host in the first region; and
program, in the first memory region, the first user data buffered in the first region and the second user data buffered in the first region.

20. The storage device of claim 19, wherein
the first memory region is an n-bit multi-level cell (MLC) region,
the second memory region is one of an m-bit MLC region or a single level cell (SLC) region,
“m” is a first natural number greater than 1,
“n” is a second natural number greater than “m”,
a first size of the first region corresponds to a second size of a first page of the first memory region,
a third size of the second region corresponds to a fourth size of a second page of the second memory region, and
the memory controller is configured to,
perform a first update operation on a mapping table in response to the padded data being completely programmed in the second memory region; and
perform a second update operation on the mapping table in response to the first user data and the second user data being completely programmed in the first memory region.
